(19) United States
(12) Patent Application Publication
(10) Pub. No.: US 2004/0119330 A1
(43) Pub. Date: Jun. 24, 2004

(54) Non-metal hub

(76) Inventor: Wen-Hao Chuang, Kaohsiung (TW)

Correspondence Address: BIRCH STEWART KOLASCH & BIRCH, PO BOX 747, FALLS CHURCH, VA, 22040-0747, US

(21) Appl. No.: 10/322,705

(22) Filed: Dec. 19, 2002

(51) Int. Cl. B60B 27/00

(52) U.S. Cl. 301/110.5

(57) ABSTRACT

An improved non-metal hub made from plastics to remedy problems occurred to conventional metal hubs mainly includes an axle which has a middle section encased in an oil impregnated tube and two ends coupled with plastic bearings, and is integrally formed with the plastic bearings and the plastic hub barrel and covered by the plastic hub barrel. The axle has conical sloped surfaces to contact closely with conical troughs of the bearings such that deviating angles occurred to the hub when operating in uneven road conditions may be nudged and corrected to achieve smooth and even rotation.

### FIELD OF THE INVENTION

The present invention relates to an improved non-metal hub and particularly a hub made from plastics.

### BACKGROUND OF THE INVENTION

The common bicycle hubs generally are made from metal. It usually includes an axle, a ball bearing, a barrel and a padding sleeve. The axle of a conventional hub is a straight rod coupled with the ball bearing. The contact between the axle and the ball bearing are points. Because of the small contact areas, when the wheels of the bicycle rotate, the tires tend to receive unbalanced forces and skew. As a result, uneven wearing occurs to the tires and service life of the tires decreases.

Moreover, as the conventional hubs are made from metal, the cost is higher. In addition, many components are required. Assembly is complex. This also increases the cost. All this has negative impact on product competitiveness.

Thus conventional,metal hubs for bicycles are not competitive in terms of manufacturing process, cost and functionality. In order to resolve the cost and effect issues, making hubs from plastics is a commendable approach. And structural design may be adopted to increase the function and performance.

### SUMMARY OF THE INVENTION

Therefore the primary object of the invention is to improve the metal hub. The invention provides plastic bearings and a hub barrel that are made from plastics. The axle has a wider middle section with two conical sloped surfaces to couple with an oil impregnated tube. The two conical sloped surfaces are coupled with slant troughs of plastics bearings. The plastics bearings and the hub barrel are made together by plastic forming processes. The bearings, oil impregnated tube and axle are encased in the hub barrel and form surface contact through the sloped and slant surfaces. Therefore rotational positioning of the hub may be achieved more precisely. And the tires may receive even forces and result in a longer service life.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2A is a perspective view of the invention, partly cut away.

FIG. 2B is a cross section taken along line 2B-2B in FIG. 2A.

FIG. 3 is a fragmentary enlarged cross section of the reinforced disk and a spoke of the invention.

FIG. 4 is a top view of the spokes and tire coupled together according to the invention.

FIG. 5 is a schematic view of another embodiment of the invention.

FIG. 6 is a cross section of the assembly according to FIG. 5.

### DESCRIPTION OF THE PREFERRED EMBODIMENTS

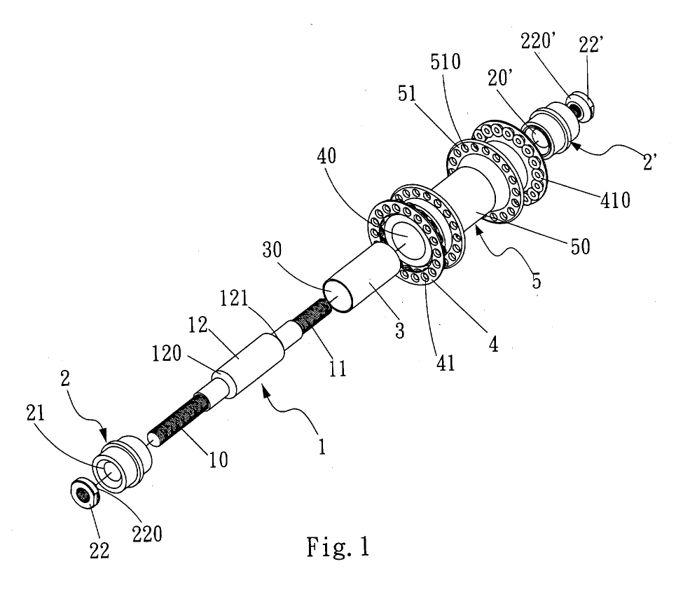

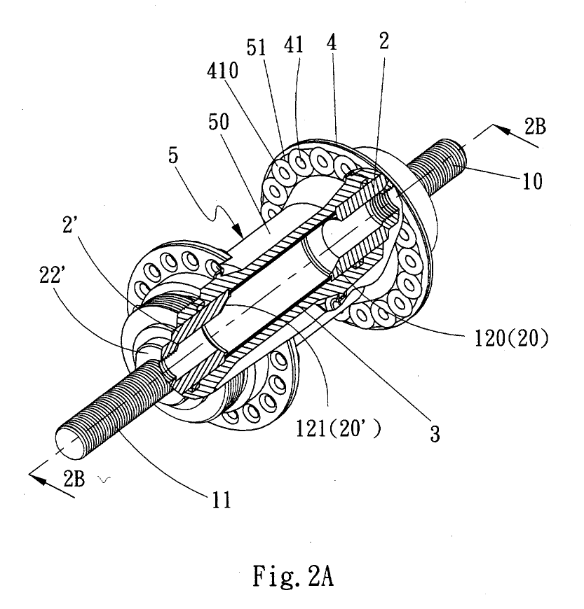

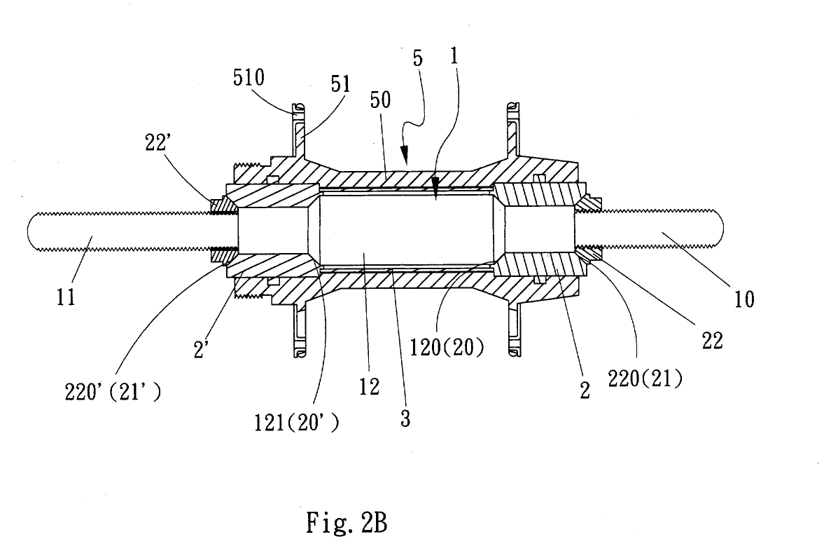

Referring to FIGS. 1 and 2A, the invention includes an axle 1, plastic bearings 2 and 2′, an oil impregnated tube 3, a reinforced disk 4 and a hub barrel 5, wherein:

the axle 1 has two ends formed screw threads 10 and 11 and a middle section 12 with a greater diameter. The middle section 12 has two ends formed conical sloped surfaces 120 and 121 to couple with the plastic bearings 2 and 2′ for positioning. The middle section 12 of the axle 1 is housed in the oil impregnated tube 3;

the plastic bearings 2 and 2′ are made from plastics and have respectively an axle hole 200 and 200′ to couple with the axle 1. The plastic bearings 2 and 2′ have respectively an inner end formed a conical trough 20 and 20′ to couple with the conical sloped surfaces 120 and 121 of the axle 1. The plastic bearings 2 and 2′ further have respectively an outer end formed a slant indented rim 21 and 21′ to couple with a conical rim 220 and 220′ of fastener 22 and 22′;

the oil impregnated tube 3 is a barrel structure with a hollow barrel 30 in the middle for encasing the middle section 12 of the axle 1 to separate the hub barrel 5 from the axle 1 for a selected distance, and is integrally formed from outside with the hub barrel 5 which has two ends each forming a reinforced disk 4;

the reinforced disk 4 is made from metal and mates and couples with a flange 51 extended from the hub barrel 5. The reinforced disk 4 has an opening 40 in the center and a plurality of apertures 41 formed annularly on the periphery thereof. Each aperture 41 has an extended flap 410 clipping two sides of the hub barrel 5; and

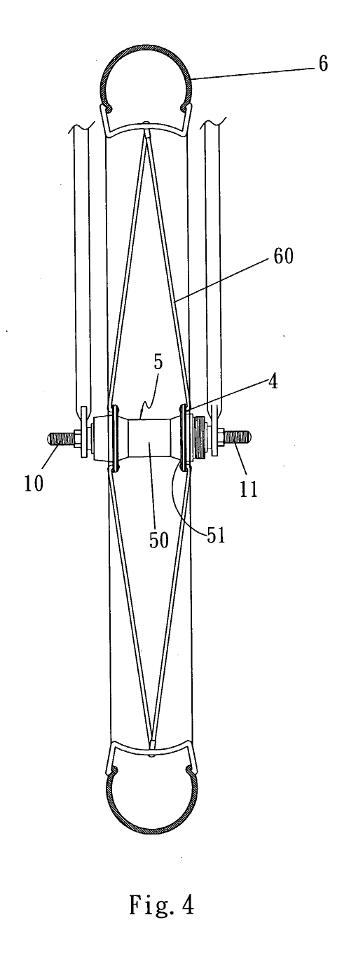

the hub barrel 5 is made from a non-metal material and formed by an injection process. It has a middle section 50 formed in a barrel structure with two ends extending respectively to form a flange 51. The flange 50 has a plurality of anchor holes 510 to engage with the spokes 60 of a wheel (referring to FIG. 4).

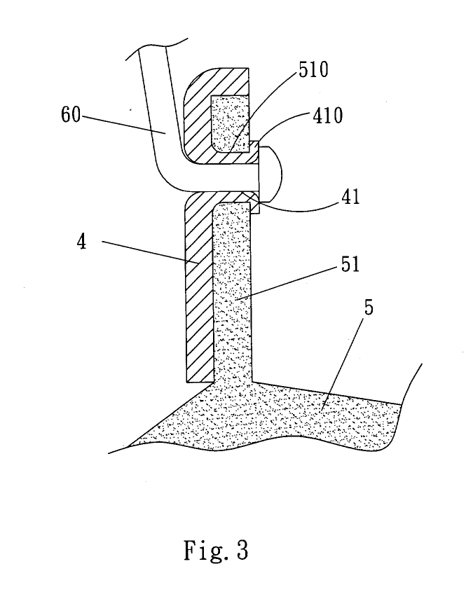

For assembly, first, couple the oil impregnated tube 3 with the middle section 12 of the axle 1, and couple the plastic bearings 2 and 2′ with the axle 1 outside the middle section and beyond the screw thread portion. Next, the resulting subassembly is integrally formed with the hub barrel 5 by an injection process and is encased in the hub barrel 5. Then the fasteners 22 and 22′ are coupled with the axle and plastic bearings to complete the assembly (as shown in FIG. 2B). By means of the separation and oil provided by the oil impregnated tube 3 and the nudging of the slant surfaces of the plastic bearings 2 and 2′, the hub barrel 5 may be positioned correctly during rotation. The spokes 60 are engaged with the apertures 41 which are coupled with the flap 410 of the reinforced disk 4 (as shown in FIGS. 3 and 4). Thus the tire 6 may receive even forces and result in a longer service life.

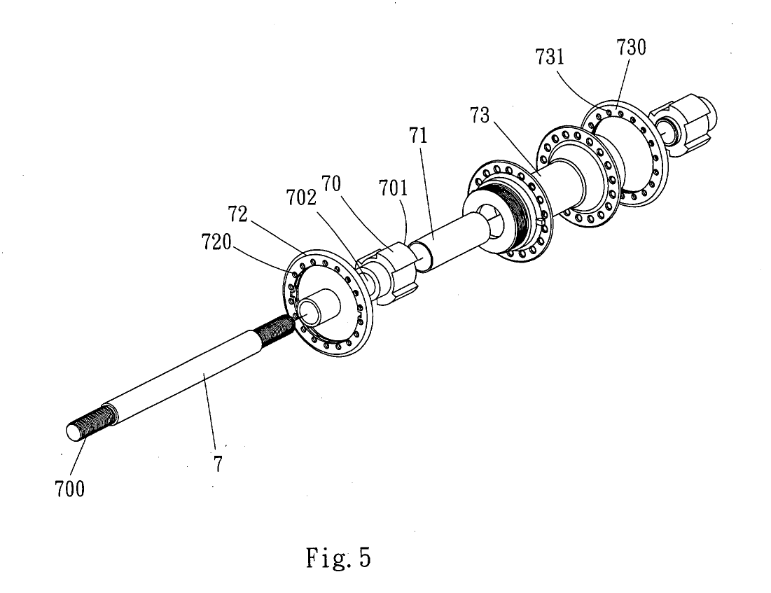

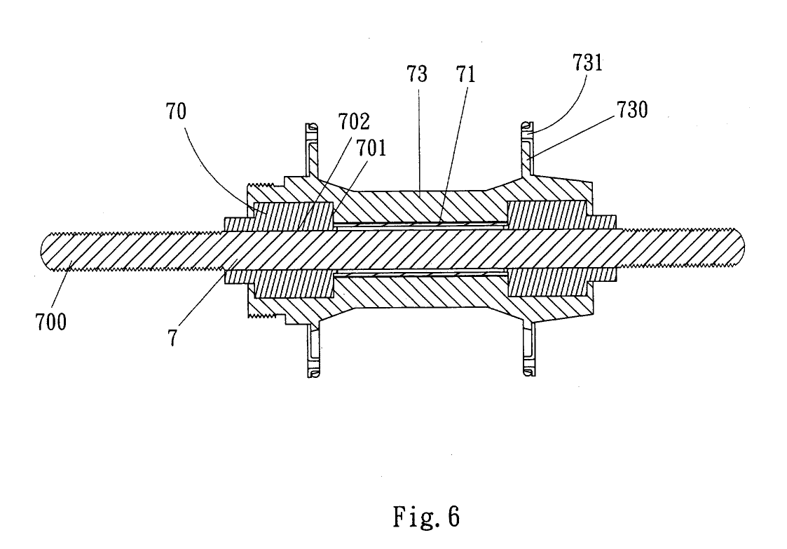

Refer to FIGS. 5 and 6 for another embodiment of the invention. It is constructed largely like the embodiment shown in FIG. 1. The difference is that the axle 1 runs through an oil impregnated tube 71 and plastic bearings 70 that located at two ends and coupled with a reinforced disk 72 and a hub barrel 73.

The non-metal hub of the embodiment set forth above includes:

an axle 7 formed in a straight rod with screw threads 700 formed on two ends;

a plastic bearing 70 having planes 701 on two ends thereof and an axle hole 702 in the center;

an oil impregnated tube 71 coupling with a middle section of the axle 7 and having a diameter slightly larger than the axle 7 to form a space to contain lube oil;

a reinforced disk 72 made from metal for coupling with a flange 730 extending from the hub barrel 73 and having a plurality of apertures 720; and

a hub barrel 73 made from a non-metal material having two sides extending respectively to form a flange 730 which has a plurality of anchor holes 731.

For assembly, couple the oil impregnated tube 71 and the plastic bearing 70 with the axle 7, and fasten tightly by fasteners. Then couple the reinforced disk 72 with the flange 730 of the hub barrel 73 to increase the strength of the flange 730 to complete the assembly.

In summary, by means of the constructions set forth above, the invention can achieve the following effects:

1. In invention is made from non-metal materials, and has a simpler manufacturing process and may result in lower cost.

2. The reinforced disk couples with the hub and can increase the strength when assembled on the wheel.

3. The surface contact between the conical sloped surfaces and the slant troughs of the plastic bearings enables the hub to return to correct positions during rotation, thus the tires may receive even forces and result in a longer service life.

What is claimed is:

1. A non-metal hub, comprising:
an axle having two ends formed screw threads and a middle section with a greater diameter, the middle section having two ends formed conical sloped surfaces;
a plastic bearing having an axle hole in the center thereof to couple with the axle, an inner end formed a conical trough to couple with the conical sloped surfaces of the axle;
an oil impregnated tube formed in a barrel structure with a hollow barrel in the middle thereof for encasing the middle section of the axle;
a reinforced disk made from metal having a plurality of apertures formed annularly on the periphery thereof, each aperture having a flap extending outwards, and
a hub barrel made from a non-metal material and formed by an injection process having two ends extending respectively to form a flange corresponding to the reinforced disk, the flange having a plurality of anchor holes;
wherein the conical sloped surfaces of the axle are in closed contact with the conical trough of the plastic bearing to nudge and correct deviating angles occurred to the hub when operating in uneven road conditions to achieve even rotation.

2. A non-metal hub, comprising:
an axle formed in a straight rod with screw threads forming on two ends thereof;
a plastic bearing having planes on two ends thereof and an axle hole in the center;
an oil impregnated tube coupling with a middle section of the axle and having a diameter slightly larger than the axle to form a space to contain lube oil;
a reinforced disk made from metal having a plurality of apertures formed on the periphery thereof; and
a hub barrel made from a non-metal material having two sides extending respectively to form a flange which has a plurality of anchor holes to couple with the reinforced disk to increase bonding strength.
